(19) United States
(12) Patent Application Publication
(10) Pub. No.: US 2015/0290547 A1
(43) Pub. Date: Oct. 15, 2015

(54) Interconnecting Dolls and Related Methods of Use

(71) Applicant: Susan May, Escondido, CA (US)

(72) Inventor: Susan May, Escondido, CA (US)

(21) Appl. No.: 14/682,718

(22) Filed: Apr. 9, 2015

Related U.S. Application Data
(60) Provisional application No. 61/977,559, filed on Apr. 9, 2014.

(51) Int. Cl. A63H 3/02; G09B 19/00

(52) U.S. Cl. CPC A63H 3/02; G09B 19/00

(57) ABSTRACT

Disclosed are preferred embodiments of the invented subject matter, which is teaching tools or play objects and related methods for entertaining children while promoting cognitive or motor skill development. In one preferred embodiment, the disclosed teaching tools or play objects are dolls with a system that enables interconnection of multiple dolls, e.g., by connecting devices attached to the dolls' appendages. Suitably, dolls may be of any type and constructed in any manner and of any materials known to those of skill in the art of doll making. Connecting devices can include buttons, zippers, clips, clasps, Velcro™, strings, ribbons, or any other connection mechanism that operate by the mating of cooperating masculine and feminine connecting parts.

### CROSS-REFERENCE TO RELATED APPLICATIONS

This application claims the benefit and priority of U.S. Prov. Pat. App. Ser. No. 61/977,559 (filed Apr. 9, 2014) entitled “Interconnecting Dolls.” That document is hereby incorporated by reference in its entirety, as if fully set forth herein.

### STATEMENT REGARDING FEDERALLY SPONSORED RESEARCH OR DEVELOPMENT

Not applicable.

### BACKGROUND OF THE INVENTION

1. Field of Invention

The present application is in the field of children's toys for cognitive, motor skill development, problem solving, and socialization.

2. Background of the Invention

In a child's mind, a doll or other toy can be many things: a substitute mother, baby brother, father, babysitter, teacher, or even a fairy godmother. To such toys, the child can say anything, with any language, in any manner. For instance, a child can confide his or her innermost thoughts to the toy knowing that it will understand and not judge him or her for those thoughts. Obediently, such toys will do as told—with the help of the controller who kindly, thoughtfully, or even hostilely guides its action. In its silence, such toys promote language and imagination. These toys allow the child first to talk (even if to himself or herself) and then to listen (to himself or herself.) Moreover, a doll never dies—the energy that keeps a doll going is the most unique form of energy—the young child's imagination.

In view of these qualities, toys have sometimes been used to teach various skills to children. However, such toys have, until this disclosure, been inadequate in many regards. For instance, some toys are capable of teaching motor skills while, at the same time, failing to teach social and/or problem solving (puzzle) skills. For example, toys like “Dress Me Emily” by International Playthings (http://www.intplay.com/shop/G02395/) teach the use of clothing connecting devices (like zippers and buttons) but place cooperating parts of the devices side-by-side so that no worthwhile thoughts or discussions are needed to mate the cooperating parts of the doll. See also, e.g.: “Learn to Dress Monkey” by Alex Toys (http://www.alextoys.com/product/learn-to-dress-monkey/); “Activity Apron” by Skil-Care Corporation (http://skil-care.com/jduploads/SkilCareCatalog2011_Full%202.pdf); “The Multi-dress Cube” by J. Case-Smith's Works (http://www.therapro.com/Multi-Dressing-Cube-On-Sale-While-Supplies-Last-P7480.aspx). Melissa and Doug make a puzzle board, but the puzzle involves the positioning of pieces on to the board rather than the mating of cooperating connecting device parts. The skills presented are independent of the puzzle concept. There is no interconnection of the motor skill elements involved. It fails to promote or require any mating of cooperating parts. www.melissaanddoug.com. Other toys may teach social or problem solving skills but either fail to be entertaining or fail to teach any type of motor skill. Yet still, other types of teaching toys are too limited because they only teach one or two skills at a time or are too focused on a single topic. This limitation is exemplified by the Children's Factory vests, which only feature one or two types of connecting mechanism for connecting the front of the vest and that can only be practically worn one-at-a-time. http://www.childrensfactory.com/catalog.php?Id=14; see also the Children's Factory dexterity or Masonite boards or other doll sets (with different gender and hair styles). Thus, a need exists for entertaining children's toys for social, cognitive, and motor skill development.

Other dolls are also known for entertaining children and teaching use of connecting devices. For instance: U.S. Des. Pat. 295771 (circa 1988) features three cooking theme dolls that can hold hands (e.g., Spaghetti Girl, the Spaghetti Chef, and Lasagna Lady); U.S. Pat. App. 2010/0113892 (circa 2010) uses an attachment device as a novelty for a doll/pillowcase combination; Mooshka, which showcases the coupling of doll hands via Velcro® U.S. Pat. No. 4,729,571 and U.S. Pub. Pat. App. Ser. No. 2002/0081940 disclose dolls with fastening patches or balls and sockets to attach the dolls to one another or other objects; and, U.S. Pat. No. 5,362,271 (circa 1994) and Ser. No. 11/551,050 (circa 1925) disclose dolls with magnetic hands. These dolls do not teach problem solving or motor skills because they have the same connecting device on all of the dolls and the device is a novelty rather than the main concept of the dolls. In other words, use of these dolls does not involve the locating and matching of different attachment devices among the set of dolls.

### SUMMARY OF THE INVENTION

In view of the foregoing, it is an objective of this disclosure to describe teaching tools or play objects and related methodologies for entertaining children, while simultaneously promoting cognitive and motor skill development in the children. It is further an objective to describe dolls and related methods that involve the use and development of more than one skill and that require development of complex relational skills. Unlike other teaching tools/play objects that may introduce multiple skills by presenting them on one object, it is a goal of this disclosure to teach the use of multiple objects that each introduce separate and different skills. Finally, this disclosure is directed to disclosing other teaching tools/play objects that do not focus solely on one individual child's entertainment and development. Instead, embodiments of the disclosed subject matter also contemplate the collective and collaborative education and entertainment of groups of children.

Disclosed are preferred embodiments of the invented subject matter, which are teaching tools, play objects, and related methods for entertaining children while promoting social, cognitive, and motor skill development.

In one preferred embodiment, the disclosed teaching tools and play objects are dolls with a system that enables interconnection of multiple dolls, e.g., by connecting devices attached to the dolls' appendages. Suitably, dolls may be of any type and generally constructed of materials known to those of skill in the art of doll making. However, the devices each feature connecting devices at distal locations, which vary on the same doll and only connect to other dolls that feature an appropriate complementary connection device. Connecting devices can include buttons, zippers, clips, clasps, loop and pile (such as Velcro®), strings, ribbons, or any other connection mechanism that operate by the mating of cooperating masculine and feminine connecting parts. See the list of connecting devices below for other, non-limiting options.

In one of the preferred embodiments, the dolls are generally humanoid and the body, head, and appendages of each doll may be constructed of any pattern with cloth, yarn, and stuffing (filler). In other embodiments, any doll construction can be used without departing from the spirit and intent of this disclosure. Optionally, clothing or other ensemble for each doll may be made of fabric in combination with accessory items such as ribbons and buttons. Suitably, each doll may feature: (a) at least one masculine (“male”) connecting part of a connecting device on the distal end of one of its appendages; and (b) at least one feminine (“female”) connecting part of a connecting device on the distal end of another one of its appendages. In a preferred embodiment, each doll may have non-cooperating male and female connecting parts on its appendages so that any one doll's appendages may not be connected together by the two connecting parts. Alternately, dolls might also feature connecting devices that do not readily admit to descriptors of “male” or “female” but that are configured to connect with another complementary component. However, interconnection of the appendages of two or more dolls may be accomplished via (i) locating a first doll with a specific connecting part on one of its appendages that cooperates with the matching or coordinating connecting part of an appendage of another doll and (ii) coupling said connecting parts.

In one mode of operation, two or more dolls may be interconnected. For example, a first doll may have a male connecting part on one hand and a female connecting part on the other hand while a second doll may have a cooperating male or female connecting part on one of its hands, whereby the two dolls may be interconnected by mating the cooperating parts of the two dolls. Suitably, mating of the cooperating parts gives the appearance of the dolls hand-holding. In another mode of operation, a set of more than two dolls may be interconnected to form a circle of dolls. For example, a plurality of dolls, each doll with non-cooperating female and male connecting parts on their individual appendages, can be sold separately so that dolls with cooperating connecting parts may collected to form the dolls of a set, wherein every doll has the capacity to join hands with two other dolls by means of the connecting device's components. Suitably, when all connecting parts on the dolls' appendages are connected in the set, the dolls may be united in a full circle.

According to one method, embodiments of the invention can be for teaching and practicing fine motor skills in children (including toddlers). For example, a plurality of dolls can be provided to accommodate the learning and dexterity levels of preschool and elementary school children as they work to match and join the dolls by means of the connecting devices. In this preferred method, the plurality of dolls can be used by one child alone or by multiple children at one time, wherein finding and joining cooperating interlocking components among the dolls is the goal. Desirably, the method not only accommodates a child's development towards parallel and then cooperative play by establishing an atmosphere that encourages communication and socialization.

The subject matter disclosed by this specification aptly describes toys, and dolls in particular, as the centerpiece for the teaching and/or enhancement of social skills, cognitive abilities, problem solving skills, and motor skills. Specifically, the subject matter described involves a system of dolls that promotes the skills of: visual/tactile discrimination of objects; bilateral coordination; fine motor practice/refinement; eye hand coordination; communication/socialization/cooperative skills; mental acuity (memory; problem solving); and self-help skills.

In one embodiment, the disclosed system promotes visual and tactile discrimination of objects by children. According to one method, a child can simply play with the dolls in typical fashion: i.e., hugging, play acting, and inventive conversation. However, the ultimate purpose is to be able to distinguish between a selection of connecting parts either through visual or tactile discrimination. Trial and error is critical to the child's natural learning and cognitive processes. This invention allows that trial and error to take place through an unthreatening approach—doll play.

In another embodiment, the disclosed system promotes bilateral coordination practice. This system focuses on the manipulation of objects, thereby allowing the child to practice those skills which enhance bilateral coordination, the use of both sides of the body to perform a task, and in this particular application, the ability to use both hands together to manipulate an object. A unique feature of this invention is that the drill and practice element is tactfully imbedded into doll play.

In another embodiment, the disclosed system involves connecting devices to promote and practice fine motor skills and eye-hand coordination. It is not unusual for dolls to have an association with each other. However, the disclosed subject matter has an educational emphasis. The user must first identify a relationship between like parts. Then, the parts must be connected. The educational element of requiring proper connection of opposing parts allows the child to practice his or her motor skills and refine his or her eye-hand coordination.

Mental acuity/problem solving/memory skills can also be taught according to one embodiment of this disclosure. Because the disclosed subject matter is composed of a selection of connecting devices, it inherently challenges the child's mental acuity to discriminate between parts and functions. It is not new for problem-solving skills and memory techniques to be promoted and practiced through toy play. However, unlike other toys that concentrate these skills onto a single object, this invention challenges the learner to make the progressive, mental leap to select an appropriate connector on a separate object, not just connect juxtaposed, matching parts. Therefore, unlike other inventions, the dressing skills that are promoted and practiced are done so in a more real life representation because the learner must select appropriate connectors from a selection of possibilities without being prompted by the proximity of like attachments.

Communication/socialization skills can be learned via the disclosed system. Socialization through doll play is not a new concept. However, because this invention has an assortment of connecting devices, a child must go beyond simple conversation and use directive and more intricate language to work with a partner(s) to properly manipulate the dolls. Thus, cooperative learning and socialization is developed because, unlike prior art, children must work together to create unique doll combinations when playing with the dolls according to this disclosure.

Other objectives and desires may become apparent to one of skill in the art after reading the below disclosure and viewing the associated figures.

### BRIEF DESCRIPTION OF THE FIGURES

The manner in which these objectives and other desirable characteristics can be obtained is explained in the following description and attached figures in which:

FIG. 1 is a front view of doll 1000 demonstrating a general appearance dolls in FIGS. 2 through 9;

FIG. 2 is a front view of doll 1;

FIG. 3 is a front view of doll 2;

FIG. 4 is a front view of doll 3;

FIG. 5 is a front view of doll 4;

FIG. 6 is a front view of doll 5;

FIG. 7 is a front view of doll 6;

FIG. 8 is a front view of doll 7;

FIG. 9 is a front view of doll 8′

FIG. 10 is a diagram for interconnecting dolls 5 and 6;

FIG. 11 is a diagram for interconnecting dolls 6 and 7;

FIG. 12 is a diagram for interconnecting dolls 1 and 2;

FIG. 13 is a diagram for interconnecting dolls 8 and 1;

FIG. 14 is a diagram for interconnecting dolls 4 and 5;

FIG. 15 is a diagram for interconnecting dolls 7 and 8;

FIG. 16 is a diagram for interconnecting dolls 2 and 3;

FIG. 17 is a diagram for interconnecting dolls 3 and 4;

FIG. 18 is a diagram for interconnecting dolls 1 through 8;

FIG. 19 shows a jumbled puzzle of dolls 1 through 8;

FIG. 20 is a completed puzzle of dolls 1 through 8; and,

FIG. 21 is a diagram for interconnecting dolls 1 through 9 as a general representation of how additional dolls can be added.

It is to be noted, however, that the appended figures illustrate only typical embodiments of the disclosed assemblies, and therefore, are not to be considered limiting of their scope, for the disclosed assemblies may admit to other equally effective embodiments that will be appreciated by those reasonably skilled in the relevant arts. Also, figures are not necessarily made to scale.

### DETAILED DESCRIPTION OF PREFERRED EMBODIMENTS

Disclosed are preferred embodiments of the invented subject matter, which are teaching tools, play objects, and related methods for entertaining children while promoting social, cognitive and motor skill development. In the preferred embodiment, the disclosed teaching tools or play objects are dolls defining a system that enables interconnection of multiple dolls, e.g., by connecting devices attached to the dolls' appendages. Suitably, dolls may generally be of any type and constructed in any manner and of any materials known to those of skill in the art of doll making. However, the devices each feature connecting devices at distal locations, which vary on the same doll and only connect to other dolls that feature an appropriate complementary connection device. Connecting devices can include buttons, zippers, clips, clasps, Velcro® (hook & loop fasteners), strings, ribbons, or any other connection mechanisms that operate by the mating of cooperating masculine and feminine connecting parts. The more specific aspects of the disclosure are described in connection with the figures.

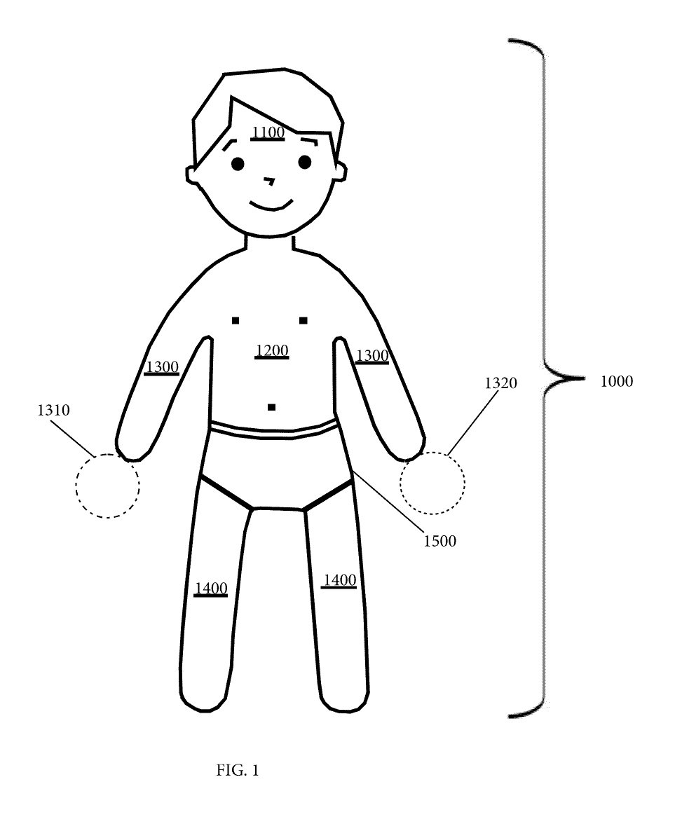

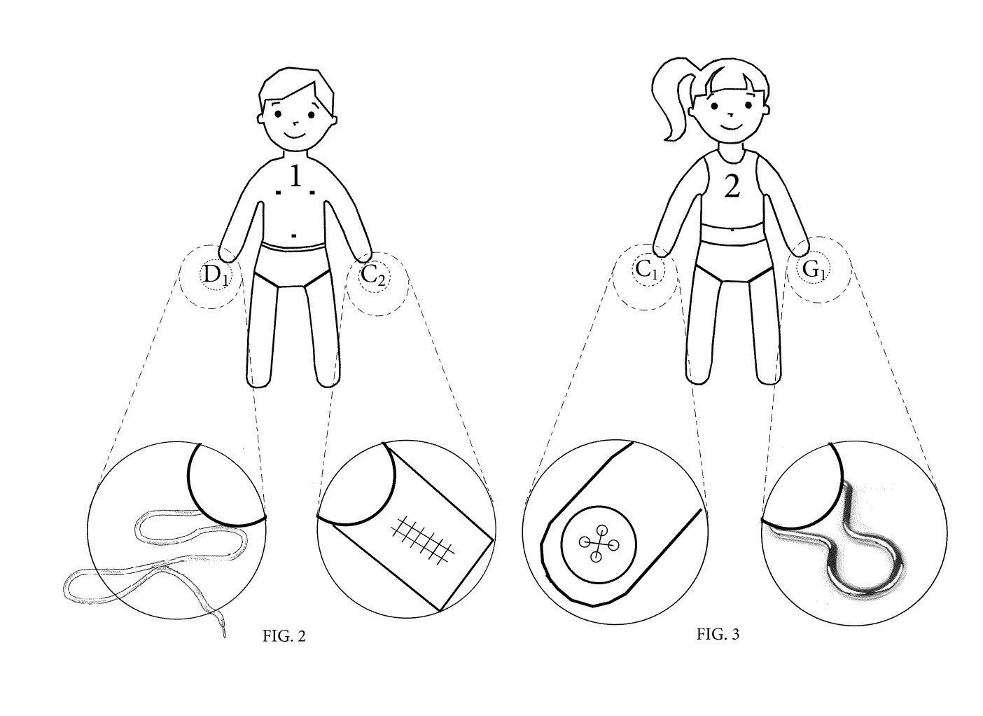

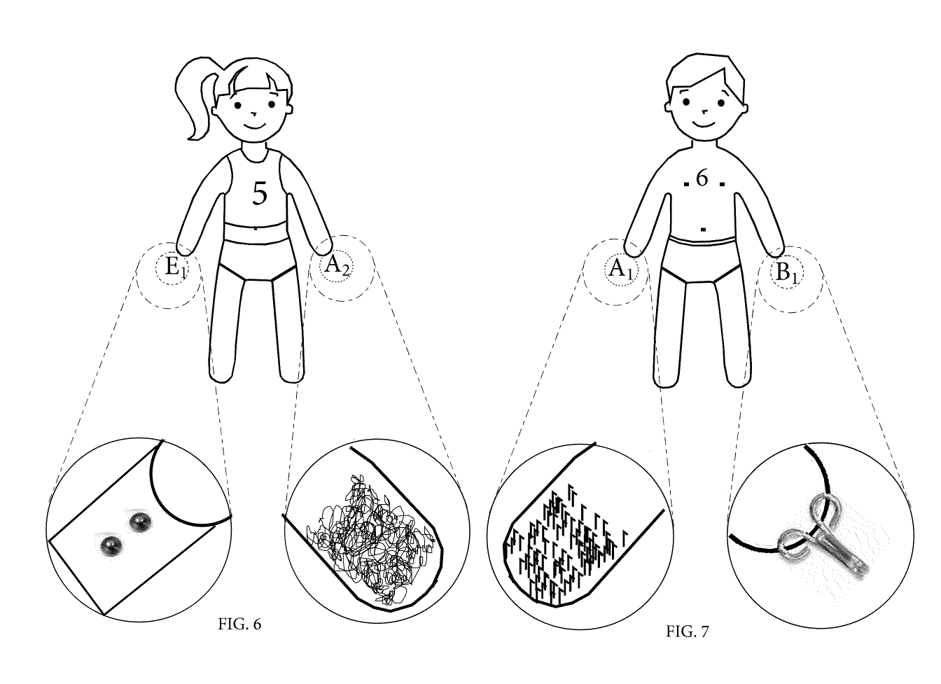

FIG. 1 is a front view of a doll 1000. As shown, the doll 1000 is a generic humanoid and features a head 1100, body 1200, arm appendages 1300, and leg appendages 1400. In one of the preferred embodiments, the body 1200, head 1100, and appendages 1300, 1400 may be constructed of any pattern with cloth, yarn, and stuffing (filler). Optionally, clothing 1500 or other ensemble for the doll 1000 may be made of fabric in combination with accessory items such as ribbons and buttons (not shown). In one preferred embodiment, the doll 1000 may suitably be twenty-two inches in length and relevantly proportioned. However, the size and proportion of the doll 1000 may vary in other embodiments without departing from the principles discussed herein. Suitably, the doll 1000 features at a distal end of at least one of its arm appendages 1300 a first male or female connecting part 1310 (shown generically) of a first connecting device. Preferably, the doll 1000 also features at a distal end of one of its arm appendages 1300 a second male or female part 1320 (shown generically) of a second connecting device that is different than the first connecting device. The connecting parts 1310, 1320 may be placed directly on the distal end of the appendage 1300 or provided to the appendage via an extension flap (i.e., a rectangular appearing flap of material extending outwardly from the distal end of the appendage 1300 (see, e.g., FIG. 2 and FIG. 6)). In the drawings the distal end of the appendage is shown as rounded and represents a hand of the humanoid doll 1000. In a preferred embodiment, each doll may have non-cooperating male and female connecting parts on its appendages so that the doll's own appendages may not be connected together by the two connecting parts of the doll. However, interconnection of the appendages of two or more dolls may be accomplished via (i) locating a first doll with a male connecting part on one of its appendages that cooperates with the female connecting part of an appendage of another doll and (ii) coupling said male and female connecting parts. Various combinations are possible as set forth in the following Table 1, which is a chart of eight possible connecting parts that may be used for interconnecting dolls.

TABLE 1

| CONNECTING | | | | |
|---|---|---|---|---|
| DEVICE | | MALE PART | | FEMALE PART |
| VELCRO ® | A₁ | Rough Side | A₂ | Soft Side |
| | | (aka Hook) | | (aka Loop) |
| HOOK & EYE | B₁ | Hook | B₂ | Eye |
| BUTTON & | C₁ | Button | C₂ | Buttonhole |
| BUTTONHOLE | | | | |
| SHOELACE | D₁ | Shoelace | D₂ | Shoelace |
| SNAP(S) | E₁ | Stud (Protruding Ball | E₂ | Socket |
| | | Portion) | | |
| CENTER BAR | F₁ | Strapping with Holes | F₂ | Center Bar Buckle with |
| BUCKLE | | | | attached Strapping |
| | | | | without Holes |
| INTERLOCKING | G₁ | Buckle (one side) | G₂ | Buckle (other side) |
| BUCKLE | | | | |
| ZIPPER | H₁ | Zipper with Insertion | H₂ | Zipper with Slider |
| | | Pin | | |

As set forth in the Table 1, connecting devices can include buttons, zippers, clips, clasps, Velcro®, strings, ribbons, or any other connection mechanism that operate by the mating of cooperating masculine and feminine connecting parts. In a Velcro type connecting device, the hooks A₁ are the male connecting part while the Loops A₂ are the female connecting part. In a Hook & Eye connecting device, the Hook B₁ is the male connecting part and the Eye B₂ is the female connecting part. In a button & Buttonhole connecting device, the button C₁ is the male connecting part and the Buttonhole C₂ is the female connecting part. In a Shoelace connecting device, a first lace D₁ is a male connecting part while a second lace D₂ is a female connecting part. In a Snap connecting device, a protruding ball E₁ is the male part while the hole or socket E₂ is the female connecting part. In a Center Bar Buckle connecting device, the Strap F₁ is the male connecting part while the Bar Buckle F₂ is the female connecting part. In an Interlocking Buckle connecting device, the connecting parts G₁, G₂ are interchangeable. Finally, in a Zipper connecting device, the teeth and pin side H₁ are the male connecting part while the teeth, box, and pull tab side H₂ are the female connecting part.

Table 2 (see below) is a chart for eight dolls (dolls 1 through 8) and the position of the male and female connecting parts of the associated connecting parts shown in FIGS. 2 through 9. It should be noted that any discussion of the drawings 2 through 21 include, when appropriate, a simultaneous reference to Table. 2.

TABLE 2

| DOLLS | LEFT HAND | RIGHT HAND |
|---|---|---|
| 1 | Buttonhole (C₂) | Shoelace (D₁) |
| 2 | Interlocking Buckle (G₁) | Button (C₁) |
| 3 | Zipper with Slider (H₂) | Interlocking Buckle (G₂) |
| 4 | Snap (Socket) (Female Part) | Zipper with Insertion Pin(H₁) |
| | (E₂) | |
| 5 | Velcro ® (Soft Side) | Snap (Stud) (Male Part) (E₁) |
| | (Loop) (A₂) | |
| 6 | Hook (B₁) | Velcro ™ (Rough Side) |
| | | (Hook) (A₁) |
| 7 | Center Bar Buckle | Eye (B2) |
| | Strapping with Holes) (F₁) | |
| 8 | Shoelace (D₂) | Center Bar Buckle (Buckle Portion |
| | | with Strapping without Holes |
| | | attached.) (F₂) |

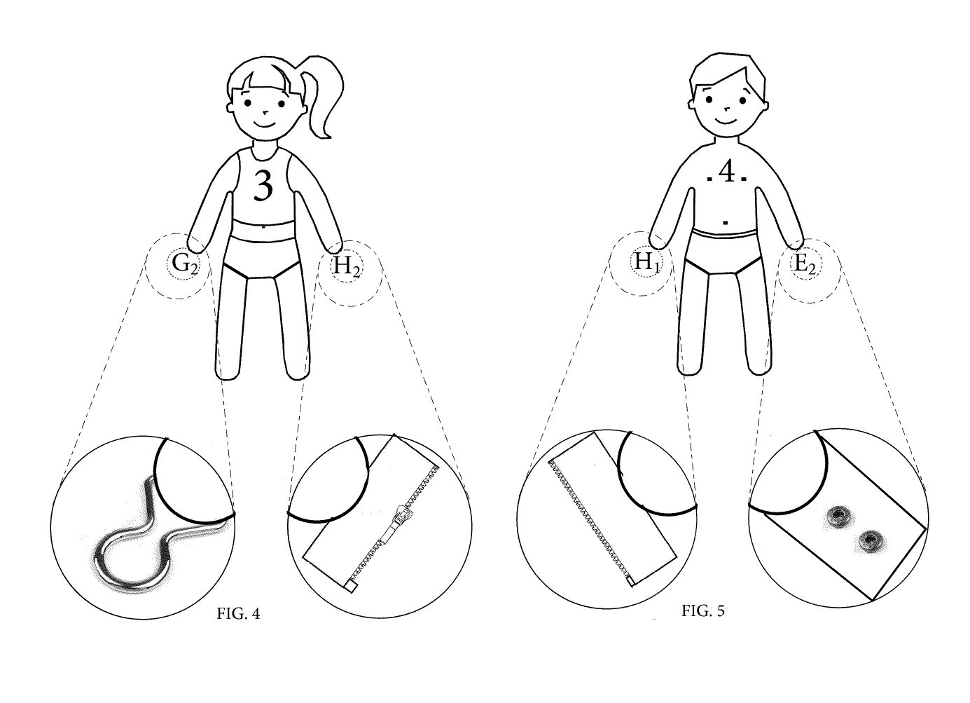

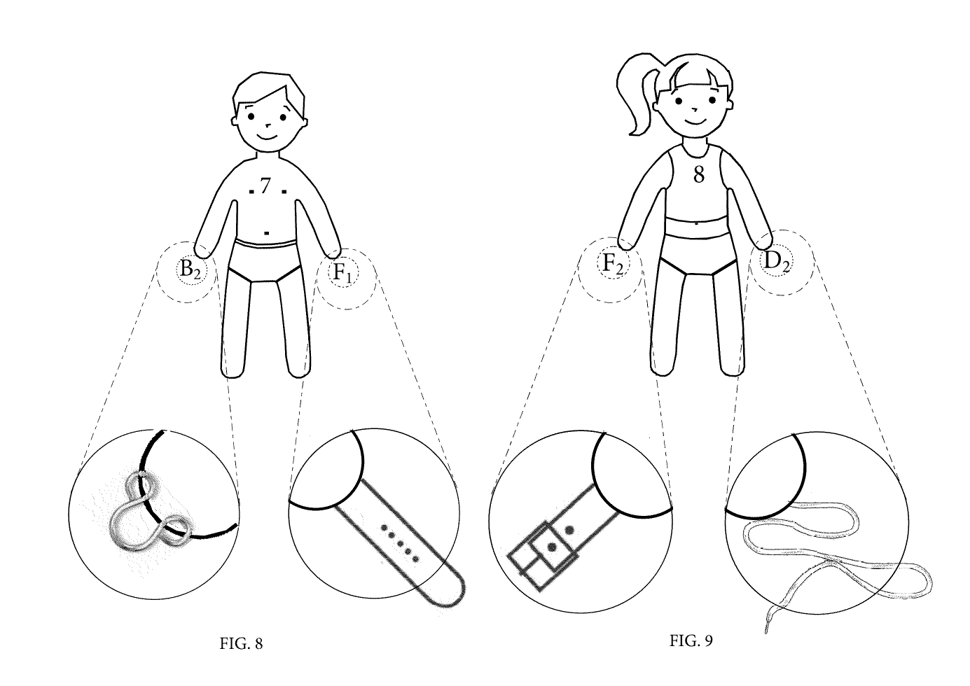

FIGS. 2 through 9 are respectively front views of dolls 1 through 8. As shown in FIG. 2, doll 1 features a Shoelace D₁ coupled to its right hand and a Buttonhole C₂ through an extension flap that is coupled to its left hand. FIG. 3 shows doll 2 with a Button C₁ coupled to its right hand and a Buckle G₁ coupled to its right hand. FIG. 4 shows a doll 3 with a Buckle G₂ on its right hand and a female zipper component H₂ coupled to its left hand. FIG. 5 shows doll 4 with a male Zipper component H₁ coupled to its right hand and a female snap component E₂ on an extension flap that is coupled to its left hand. FIG. 6 shows doll 5 with a male Snap Button E₁ on an extension flap that is coupled to its right hand and loops A₂ on its left hand. FIG. 7 shows doll 6 with Hooks A₁ on its right hand and a Hook B₁ coupled to its left hand. FIG. 8 shows doll 7 with an Eye B₂ coupled to its right hand and a Strap F₁ coupled to its left hand. FIG. 8 shows doll 8 with a Buckle F₂ coupled to its right hand and a Shoelace D₂ coupled to its left hand.

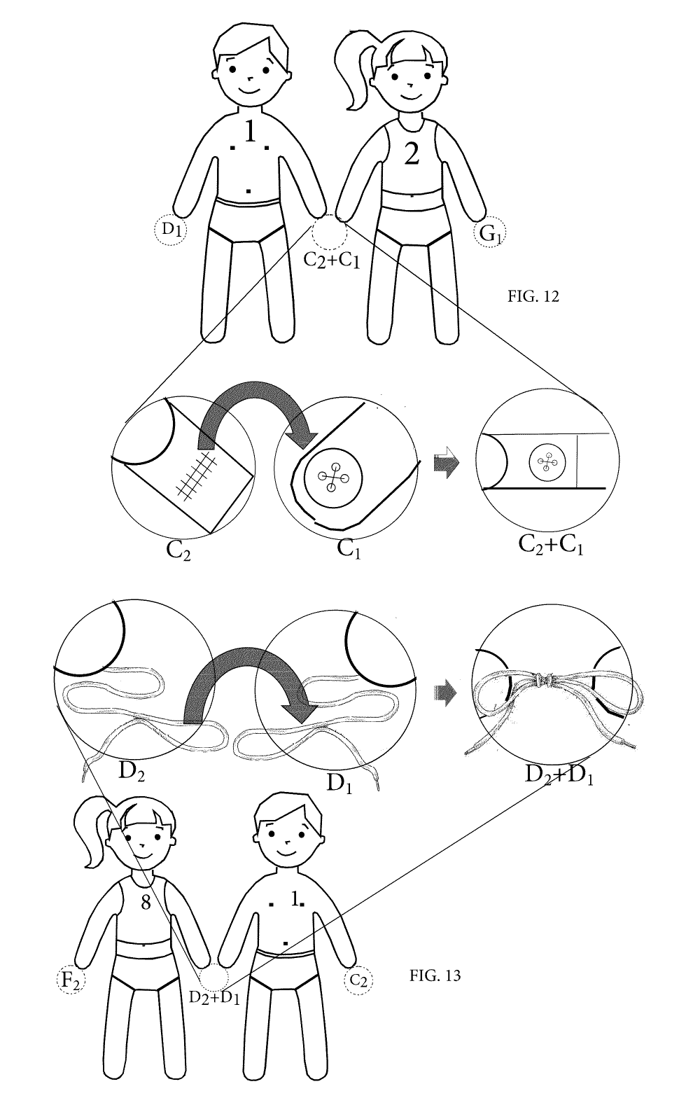

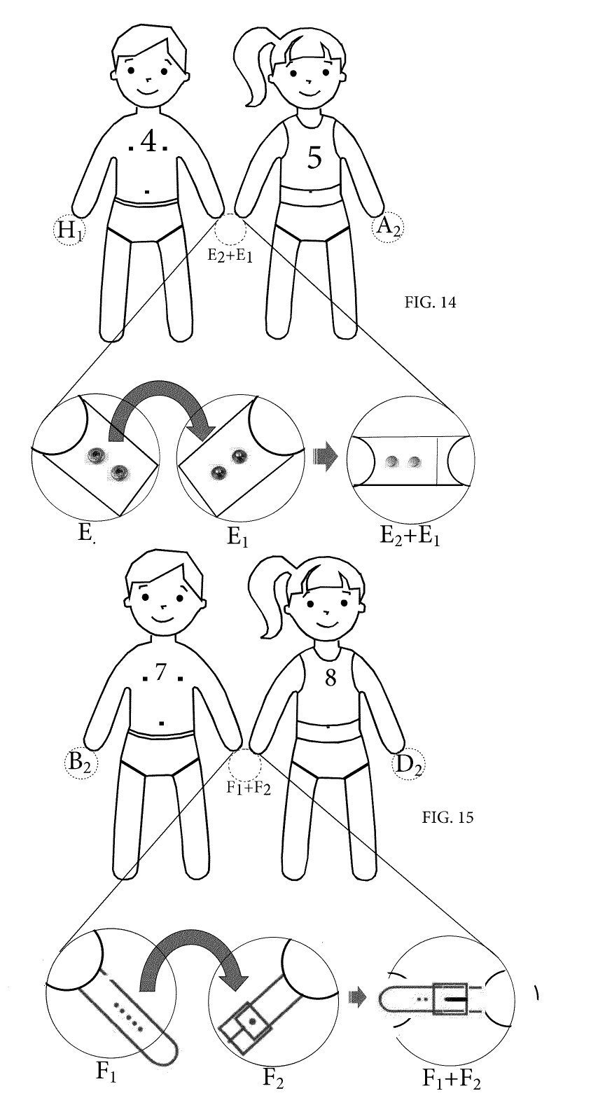

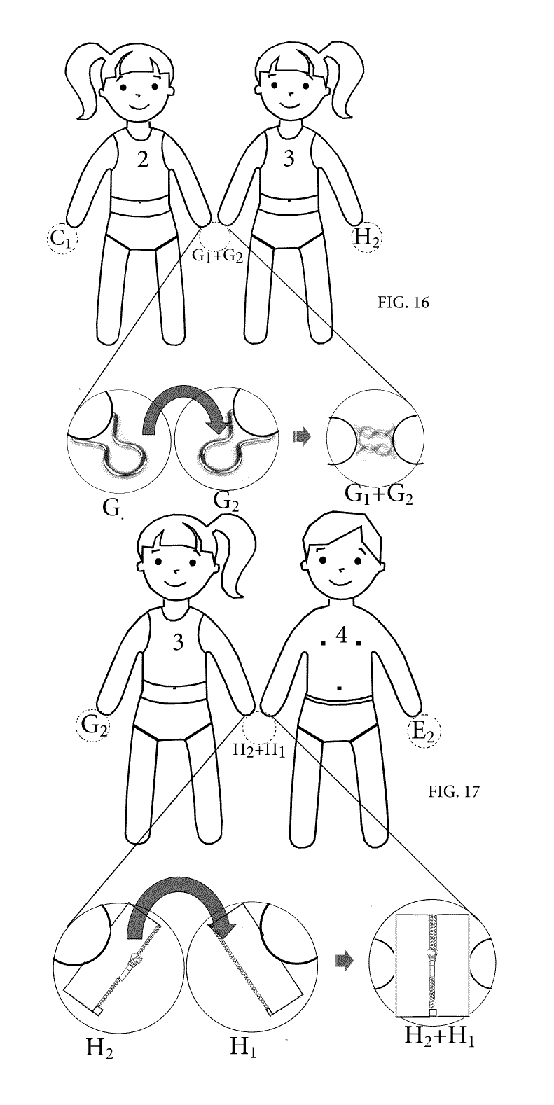

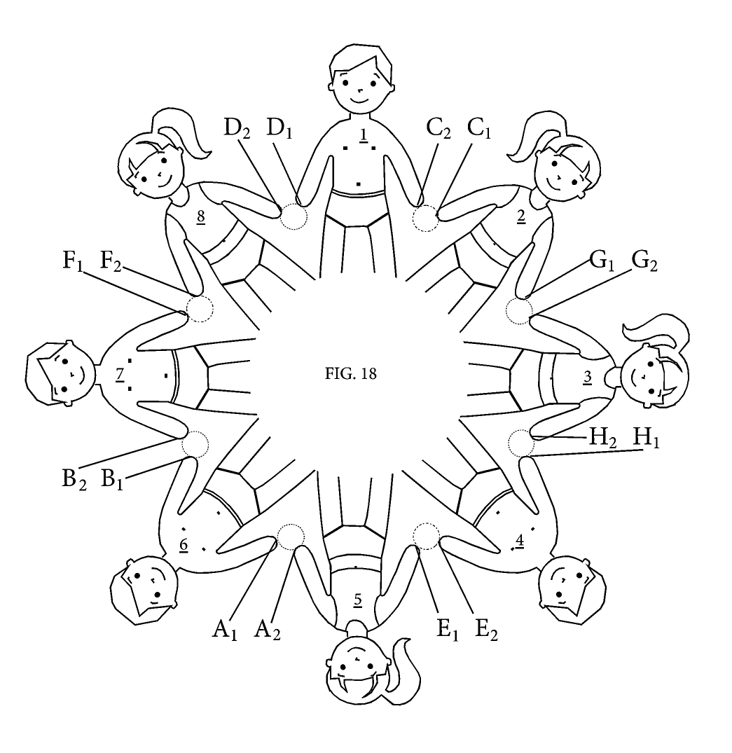

FIGS. 10 through 17 illustrate the coupling of component connecting parts of the devices set forth in Table 1 according to the chart of Table 2. FIG. 10 is a diagram for interconnecting dolls 5 and 6 via a Velcro connecting device A₂+A₁. As shown the Hooks A₁ on the right hand of doll 6 are interconnected with the Loops A₂ on the left hand of doll 5. FIG. 11 is a diagram for interconnecting dolls 6 and 7 via a Hook & Eye connecting device B₁+B₂. Referring to that figure, the Hook B₁ on the left hand of doll 6 is coupled with the Eye B₂ on the right hand of doll 7. FIG. 12 is a diagram for interconnecting dolls 1 and 2 via a Button & Buttonhole connecting device C₂+C₁. In FIG. 12, the Button C₁ on the right hand of doll 2 is provided through the Buttonhole C₂ in the extension flap coupled to the left hand of doll 1. FIG. 13 is a diagram for interconnecting dolls 8 and 1 via a Shoelace connecting device D₂+D₁. This figure shows that a first lace D₁ on the right hand of doll 1 is tied to a second lace D₂ that is coupled to the left hand of doll 8. FIG. 14 is a diagram for interconnecting dolls 4 and 5 via a Snap connecting device E₂+E₁. FIG. 14 shows that two male Snaps E₁ on an extension flap from the right hand of doll 5 is coupled to two female Snaps E₂ on an extension flap from the left hand of doll 4. FIG. 15 is a diagram for interconnecting dolls 7 and 8 via a Center Bar Buckle F₁+F₂. The figure shows that a Strap F₁ from the left hand of doll 7 may be interconnected with the Buckle F₂ extending from the right hand of FIG. 8. FIG. 16 shows the interconnecting of dolls 2 and 3 via an Interlocking Buckle connecting device G₁+G₂. In this illustration, the Interlocking Buckle G₁, G₂ from the left and right hands of dolls 2 and 3 respectively are interconnected. Finally, FIG. 17 shows dolls 3 and 4 being interconnected via a Zipper connecting device H₂+H₁. As shown, the teeth and pin side H₁ from the right hand of doll 4 may be mated with the teeth, box, and pull tab side H₂ on the left hand of doll 3.

FIG. 18 shows a circle of dolls (dolls 1 through 8) interconnected according to the principles described above. For example, a plurality of dolls, each doll with non-cooperating female and male connecting parts on their individual appendages can be sold separately so that dolls with cooperating connecting parts may be collected to form the dolls of a set, wherein every doll has the capacity to join hands with two other dolls by means of the connecting device's components. Suitably, when all connecting parts on the dolls' appendages are connected in the set, the dolls may be united in a full circle.

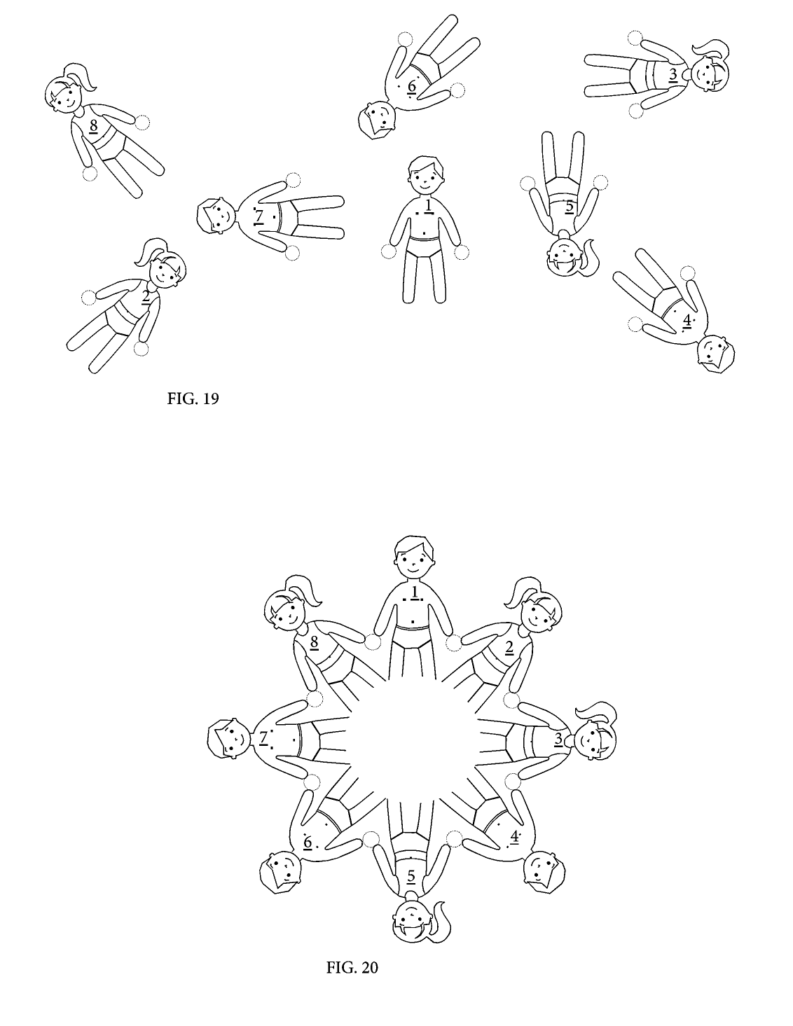

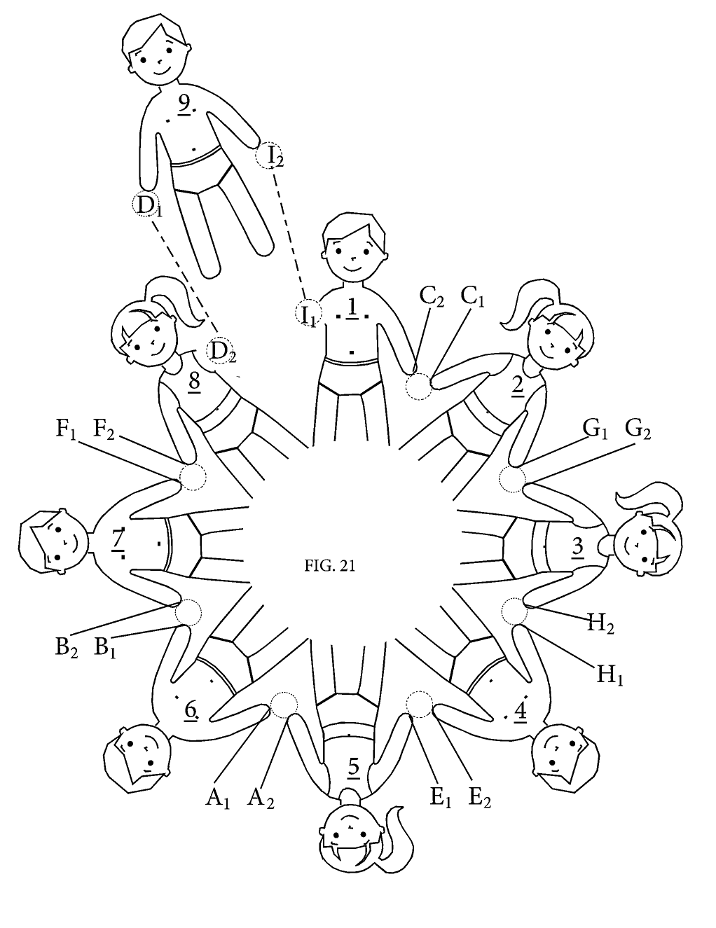

According to one method, embodiments of the invention can be for teaching and practicing fine motor skills in children (including toddlers). For example, a plurality of dolls can be provided to accommodate the learning and dexterity levels of preschool and elementary school children as they work to match and join the dolls by means of the connecting devices. In this preferred method, the plurality of dolls can be used by one child alone or by multiple children at one time, wherein finding and joining cooperating interlocking components among the dolls is the goal. Desirably, the method not only accommodates a child's inclination towards parallel play, but also establishes an atmosphere that encourages communication and socialization through cooperative play. This method can be illustrated by FIGS. 19 and 20. FIG. 19 shows dolls 1 through 8 in a jumbled state. Suitably, the connecting parts of each doll may be matched with cooperating coupling parts of the other dolls until the dolls are arranged in a circle with all cooperating parts mated. This circle of dolls is the end product and is shown in FIG. 20.

FIG. 21 shows a chain of eight dolls (dolls 1 through 8) that is being completed by the interconnection of a ninth doll (doll 9) with the dolls at the end of the chain (dolls 1 and 8). Suitably, all dolls may be interconnected according to the principles described above. For example, a plurality of dolls, each doll with non-cooperating female and male connecting parts on their individual appendages, can be sold separately so that dolls with cooperating connecting parts may be collected to form the dolls of a set, wherein every doll has the capacity to join hands with two other dolls by means of the connecting device's components. Suitably, when all connecting parts on the dolls' appendages are connected in the set, the dolls may be united in a full circle. In one mode, the figure illustrates that circles of dolls can be formed with more or less than eight dolls.

### Example

### Eight Piece Doll Set

Below is a description of how to accomplish the disclosed teaching tool and related methods while using an eight piece doll set described above.

Doll Construction:

To construct a doll, obtain: fabric, stuffing, yarn, and embellishments such as ribbons and buttons. Referring to FIGS. 2 through 9, construct eight dolls while leaving an opening (a not sewn portion) at the end of: (a) the Left Hand of Doll 1; (b) the Left Hand of Doll 4 and the Right Hand of Doll 5; (c) the Left Hand of Doll 8 and the Right Hand of Doll 1; and, (d) the Left Hand of Doll 7 and the Right Hand of Doll 8.

The openings should be ¼ inch wider than the width of an extension tab. Once extension tabs have been made, the extension tabs will be inserted into the openings. Three extension tabs are needed if utilizing cloth/fabric dolls. One extension tab is needed for the Buttonhole connecting device (on the left hand of doll 1 (see FIG. 2) and two extension tabs are needed for the Snap(s) connecting device (on the right hand of doll 5 (see FIG. 6) and the left hand of doll 4 (see FIG. 5)). The extension tabs may be made of the same fabric as the dolls' bodies.

Directions for Making an Extension Tab:

First, cut two pieces of rectangular fabric one and one half times the length of the doll's hand and the same width as the doll's hand. Second, place the cut fabric pieces matching the right side of the fabric to the right side of the other fabric and machine or hand stitch ⅝ inches in from the cut edge around three sides (both lengths and one width) leaving one width not sewn. Third, trim the sewn edges to ¼ inch from the stitching. Fourth, turn the fabric right side out and iron flat. Fifth, make three more extension tabs using the same method. Finally, the finished tab should be no less than 3½ inches long and 1⅜ inches wide.

Attaching Connecting Devices to Extension Tabs:

Before attaching the extension tabs to the dolls' hands, design each tab with its appropriate connecting device.

Buttonhole Connecting Device

Constructing the Buttonhole:

(Note: First, create a test Buttonhole on a spare piece of fabric in order to make sure that the Button can slide in and of the Buttonhole without resistance, yet stay in place when the Button is inserted into the hole.) To begin, machine stitch either a standard Buttonhole, square Buttonhole, or bound Buttonhole positioned so that it runs the length of one tab with one end positioned ½ inch in from the finished width of the tab to allow ample room for the Button to slide in and out of the Buttonhole easily. The finished length of the Buttonhole should be at least the diameter of the Button plus ¼ inch. Then, open the Buttonhole using sharp scissors or a seam ripper.

Snap(s) Connecting Device

Placement and Attachment of Hole Portion of Snap:

Here, the hole portion of the Snap consists of a decorative prong and a socket. The hole portion should be at least 7/16 inch and no larger than 10/16 inch in diameter. Using a chalk pencil, make two marks on the outside of an extension tab that has already been constructed. (See “Directions for making an extension tab” above.) Make the first mark so that it is centered from side to side across the width of the tab and ¾ inch in from the end of the tab's outermost, finished end. (This is the short end that is opposite the tab end that has not yet been sewn closed.) Make the second chalk mark 1¼ inches from the first mark and closer to the unfinished end, making sure that the two marks are each equal distant from the sides of the tab. Next, place the first, decorative prong so that its center is positioned directly over one of the marks and the prongs are facing the tab's fabric. Press the prongs through the fabric so that they protrude through the underside of the tab. (If necessary, work on a hard surface, place the decorative prong with the prongs facing upward, position the tab over the prongs making sure that it is centered with the chalk mark, and use the eraser end of a pencil to push down the fabric until the prongs pierce through.) Next, position the socket over the protruding prongs so that the prongs fit into the groove around the socket's hole making sure that the side of the socket that is facing the prongs is the side that appears to have the smaller opening. Using the end of a spool, place it over all prongs at once, and press down evenly so that the prongs bend into the socket and secure the socket to the decorative prong piece.

Placement and Attachment of Stud (Male Protruding Ball) Portion of Snap:

In a preferred embodiment, the Stud Portion of the Snap consists of a regular prong and a stud, which is a protruding ball portion. First, make two marks on an extension tab that has not yet been utilized. Second, position the marks so that the center of each mark will line up with the center of the hole portion of the Snap(s) connecting device that has already been completed on a separate tab. Working on a hard surface, place the regular prong with the points facing upward. Third, position the tab with its chalk markings so that the chalk marking is in the center of the regular prong. Fourth, press down using the eraser end of a pencil so that all prongs have protruded through to the opposite side of the tab. Fifth, place the stud (protruding ball portion) so that it is directly over the protruding prongs and the protruding ball is facing outward (away from the fabric). If properly placed, the prong points will fit into a groove encircling the stud. Sixth, place a spool over the stud so that the hole in the spool is directly over the protruding ball portion. Finally, gently hammer the spool so that the stud is secured to the prong.

Attaching Extension Tabs to Openings in Dolls' Hands

Attaching the Buttonhole Connecting Device Tab:

Referring to FIG. 2, to attach the Buttonhole connecting device tab, obtain Doll 1 (Left Hand), which has the extension tab with the Buttonhole attached to its Left Hand. Insert the not sewn end of the Buttonhole extension tab into the opening in the left hand of Doll 1 making sure that it is inserted ½ inch into the hand and that the finished side that shows the lips of the bound Buttonhole is on the front of the doll (the top of the hand and not on the underside of the hand). If the tab has a machine-worked square Buttonhole, then either side of the tab may be considered the finished side and may be inserted ½ inch into the hand. Then, machine stitch the hand opening closed, so that the tab is securely sewn into position.

Attaching the Snap(s) Connecting Device Tabs:

As shown in FIG. 5, Doll 4 (Left Hand) has the extension tab with the Socket (Female) portion of the Snap attached to its Left Hand. To achieve this configuration, insert the not sewn end of the Socket (female) portion of the Snap extension tab (that consists of the decorative prong and socket) into the opening in the left hand of Doll 4 making sure that it is inserted ½ inch into the hand and that the finished side that shows the decorative part of the Snap is facing the front of the doll (the top of the hand and not the underside of the hand). Then, machine stitch the hand opening closed so that the tab is securely sewn into position.

As shown in FIG. 6, Doll 5 (Right Hand) has the extension tab with the stud (male, protruding ball portion) of the Snap attached to its right hand. Insert the not sewn end of the male protruding ball portion of the extension tab (that consist of the regular prong and a stud) into the opening of the right hand of doll 5 making sure that it is inserted ½ inch into the hand and that the finished side that shows the protruding ball portion is facing the front of the doll (the top of the hand and not the underside of the hand). Then, machine stitch the hand opening closed so that the tab is securely sewn into position.

Attaching Connecting Devices (that do not Require Extension Tabs) to Openings in Dolls' Hands

Placement and Attachment of Button:

Referring to FIG. 3, to place and attach a Button on Doll 2 (Right Hand), obtain a Button that is ¾ to 1 inch in diameter. Next, position the Button so that it is ½ inch from finished end of the doll's hand and centered from side to side across the width of the hand. Then, sew the Button into place.

Attaching the Shoelace Connecting Device:

Referring to FIG. 2, Doll 1 (Right Hand) has one Shoelace attached to its Right Hand.

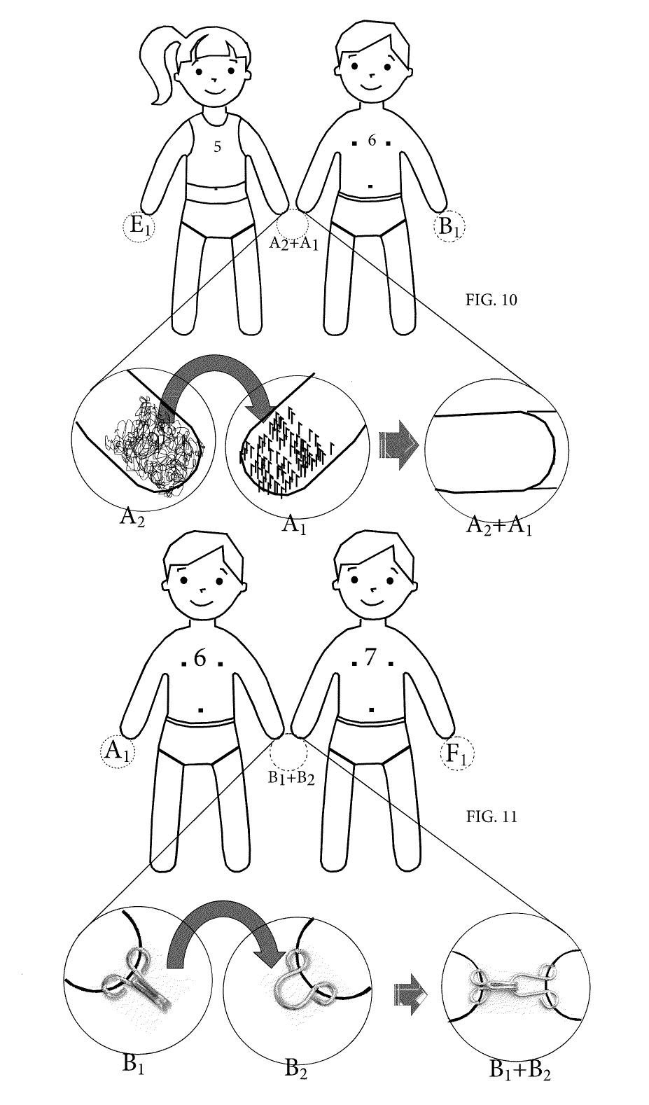

Referring to FIG. 9, Doll 8 (Left Hand) has one Shoelace attached to its Left Hand.

Using a pair of Shoelaces (preferably ones with a decorative theme), cut off the tip of one end of each lace so that each lace has a cut (raw) end and a finished tip (aglet) on the other end. Each Shoelace, after being cut, should measure 19 inches.

With respect to Doll 1, insert the cut (raw) end of one lace into the open end of the left hand of Doll 1 making sure that the end is inserted ½ inch. Then, machine stitch the hand opening closed so that the tab is securely sewn into position.

With respect to Doll 8, insert the cut (raw) end of one lace into the open end of the left hand of Doll 8 making sure that the end is inserted ½ inch. Then, machine stitch the hand opening closed so that the tab is securely sewn into position.

Attaching the Interlocking Buckle Connecting Device: (Both Sides of the Interlocking Buckle are Identical.)

Referring to FIG. 3, Doll 2 (Left Hand) has one side of the Interlocking Buckle attached to its Left Hand.

Referring to FIG. 4, Doll 3 (Right Hand) has one side of the Interlocking Buckle attached to its Right Hand.

With respect to Doll 2, anchor the Interlocking Buckle to the left hand of Doll 2 by knotting a double thickness of thread and introduce it from the underside of the hand's fingertip edge, over the bar (or frame) at the far end of the Interlocking Buckle, and down through the fabric. Repeatedly poke the needle from the underside of the hand up through the fabric, over the frame of the Interlocking Buckle, and back through the fabric (using a satin stitch) for the length of the frame section that is opposite the connecting side of the Interlocking Buckle. When the Interlocking Buckle is secure, knot the thread on the underside of the hand. Note: Proper placement of the Interlocking Buckle is so that only the frame's end is sewn to the hand and the remainder of the Buckle hangs free of any fabric. Be sure that both sides of the Interlocking Buckle angle in the appropriate direction, so that the Buckle operates properly when opened and closed.

With respect to Doll 3, anchor the Interlocking Buckle connecting device to the right hand of Doll 3 by knotting a double thickness of thread and introduce it from the underside of the hand's fingertip edge, over the bar (or frame) at the far end of the Interlocking Buckle, and down through the fabric. Repeatedly poke the needle from the underside of the hand up through the fabric, over the frame of the Interlocking Buckle, and back through the fabric (using a satin stitch) for the length of the frame section that is opposite the connecting side of the Interlocking Buckle. When the Interlocking Buckle is secure, knot the thread on the underside of the hand.

Attaching the Zipper Connecting Device:

Referring to FIG. 4, Doll 3 (Left Hand) has the side of the separating Zipper that has the slider device attached to its Left Hand.

Referring to FIG. 5, Doll 4 (Right Hand) has the side of the separating Zipper that has the insertion pin attached to its right hand. First, use a 3 inch Zipper as the Zipper connecting device. Before attaching the Zipper to the doll's hands, fold to the back of the Zipper the top tape ends and sew them securely into place, so that they neither extend past the top tape stops, nor interfere with the slider mechanism when it is used to open and close the Zipper. Then, fold to the back of the Zipper the bottom tape ends and sew them securely into place so that they neither extend past the bottom stop, nor interfere with the slider mechanism when it is used to open and close the Zipper.

FIGS. 4 and 5 may be referenced for attachment of the Zipper connecting device. to attach the Zipper connecting device on Doll 3, place the middle third of the Zipper tape edge of the Zipper's side that holds the slider device so that it barely overlaps the fingertip end of the doll's left hand, making sure that the slider is facing the front of the doll (the top of the hand and not the underside of the hand). Then, using a running stitch, sew back and forth over this middle section until it is securely attached to the doll's hand.

To attach the Zipper connecting device on Doll 4 (FIG. 5), place the middle third of the Zipper tape edge of the Zipper's side that holds the insertion pin so that it barely overlaps the fingertip end of the doll's right hand, making sure that the insertion pin is facing the front of the doll (the top of the hand and not the underside of the hand). Then, using a running stitch, sew back and forth over this middle section until it is securely attached to the doll's hand.

Attaching the Velcro® Connecting Device:

Referring to FIG. 6, Doll 5 (Left Hand) has the Loop side of the Velcro® attached to its Left Hand.

Referring to FIG. 7, Doll 6 (Right Hand) has the Hook side of the Velcro® attached to its Right Hand.

To attach the Velcro® connecting device displayed on Doll 5, obtain a piece of Velcro® measuring ¾ of the length of the doll's hand and place the Velcro® on the underside of the left hand with the length running from what would be the wrist of the doll toward the fingertip end of the hand making sure that the Loops (soft side) are facing upwards and not against the doll's hand. Using a running stitch, sew completely around the outer edge of the Velcro® to hold it in place, being sure that the thread is knotted at the beginning and end of sewing this perimeter.

To attach the Velcro® connecting device displayed on Doll 6, obtain a piece of Velcro® measuring ¾ of the length of the doll's hand, place the Velcro® on the top of the right hand with the length running from what would be the wrist of the doll toward the fingertip end of the hand making sure that the Hooks (rough side) are facing upwards and not against the doll's hand. Using a running stitch, sew completely around the outer edge of the Velcro® to hold it in place, being sure that the thread is knotted at the beginning and end of sewing this perimeter.

Attaching the Hook and Eye Connecting Device:

Referring to FIG. 7, Doll 6 (Left Hand) has the Hook connecting device attached to its Left Hand.

Referring to FIG. 8, Doll 7 (Right Hand) has the Eye connecting device attached to its Right Hand.

To attach the Hook and Eye connecting device, use a rounded Hook and Eye clasp that preferably has a thread covering (none of the bare metal is showing) whose overall length is no less than a standard size Hook and Eye (i.e., the Hook is ½ inch and the Eye is ⅜ inch).

To attach the Hook and Eye connecting device displayed on Doll 6, place the Hook portion of the connecting device onto the underside of the fingertip end of the doll's left hand so that the circled ends used for securing the Hook to the fabric are barely overlapping the doll's hand with the open end of the Hook extending beyond the end of the hand and facing up in the same direction as the front of the doll (not facing the back of the doll). Use a satin stitch through each circled end of the Hook to securely fasten the Hook to the doll's hand making sure to knot the thread at both ends.

To attach the Hook and Eye connecting device displayed on Doll 7, place the Eye portion of the connecting device onto the underside of the fingertip end of the doll's right hand, so that the circled ends used for securing the Eye to the fabric are barely overlapping the doll's hand with the open end of the Eye facing outward, away from the hand. Use a satin stitch through each circled end of the Hook to securely fasten the Hook to the doll's hand making sure to knot the thread at both ends.

Attaching the Center Bar Buckle Connecting Device:

Referring to FIG. 8, Doll 7 (Left Hand) has the Center Bar Buckle Strapping with holes device attached to its Left Hand.

Referring to FIG. 9, Doll 8 (Right Hand) has the Center Bar Buckle (attached to Strapping which is without holes) device in its Right Hand.

In a preferred method, the Strapping for each portion of the device should be ½ to ¾ of an inch wide. The length of Strapping that does not have holes should be 3½ inches. The portion of the device that has the Strapping with the Center Bar Buckle attached should have a total length of 3 inches (which includes the Buckle and the Strapping).

To attach the Center Bar Buckle connection device displayed on Doll 7, insert the Center Bar Buckle Strapping approximately ½ inch into the opening in the left hand so that the length of the Strapping extends outward from the fingertip section of the hand. The finished end of the Strapping should be exposed with the unfinished end within the hand. Using a running stitch, anchor the Strapping to the hand making sure that the thread has been properly knotted at the beginning and end of stitching.

To attach the Center Bar Buckle connection device displayed on Doll 8, insert the Strapping with bar Buckle attached device ½ inch into the opening in the right hand so that the Strapping extends outward from the fingertip section of the hand and the Buckle portion the farther from the doll's hand. Using a running stitch, anchor the Strapping to the hand making sure that the thread has been properly knotted at the beginning and end of stitching.

The claims filed herewith are incorporated herein by reference in their entirety into the specification as if fully set forth herein.

Other features will be understood with reference to the drawings. While various embodiments of the method and apparatus have been described above, it should be understood that they have been presented by way of example only, and not of limitation. Likewise, the various diagrams might depict an example of an architectural or other configuration for the disclosed method and apparatus, which is done to aid in understanding the features and functionality that might be included in the method and apparatus. The disclosed method and apparatus is not restricted to the illustrated example architectures or configurations, but the desired features might be implemented using a variety of alternative architectures and configurations. Indeed, it will be apparent to one of skill in the art how alternative functional, logical or physical partitioning and configurations might be implemented to implement the desired features of the disclosed method and apparatus. Also, a multitude of different constituent module names other than those depicted herein might be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “module” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

I claim:

1. A teaching tool for entertaining children while promoting cognitive and motor skill development, said tool comprising:
a system that enables interconnection of at least two dolls by connecting devices attached to the dolls' appendages;
wherein each doll features connecting devices on each of its appendages that do not complement and connect to one another but wherein each connecting device on each appendage is operationally configured to connect with a complementary appendage of a separate doll.

2. The teaching tool of claim 1 wherein the connecting devices are selected from any of the group consisting essentially of buttons, zippers, clips, clasps, hook & loop, strings, or ribbons.

3. A method of promoting puzzle solving skills comprising the steps of:
obtaining a first doll with a male connecting part of a connecting device coupled to an appendage of the first doll;
obtaining a second doll with a cooperating female connecting part of the connecting device coupled to an appendage of the second doll;
jumbling the second doll among a plurality of dolls;
making available the first doll to a child; and,
allowing the child to locate the second doll and mate the male and female connecting parts of the connecting device.

4. The method of claim 3 further comprising the step of completing a puzzle by locating a third doll with male connecting part that cooperates with a female connecting part on a second appendage of the first doll and mating the female connecting part of on the second appendage of the first doll with the male connecting part of the third doll.

5. The method of claim 4 wherein the dolls form a circle.

6. A system of eight dolls comprising:
A first doll featuring a shoelace coupled to its right hand and a buttonhole through an extension flap that is coupled to its left hand;
A second doll with a button coupled to its right hand and a buckle coupled to its right hand;
A third doll with a buckle on its right hand and a female zipper component coupled to its left hand;
A fourth doll with a male zipper component coupled to its right hand and a female snap component on an extension flap that is coupled to its left hand.
A fifth doll with a male snap button on an extension flap that is coupled to its right hand and loops on its left hand.
A sixth doll with hooks on its right hand and a hook coupled to its left hand;
A seventh doll with an eye coupled to its right hand and a strap coupled to its left hand; and
An eighth doll with a buckle coupled to its right hand and a shoelace coupled to its left hand.

7. The system of claim 6 where the shoelace of the first doll is mated with the shoelace of the eighth doll.

8. The system of claim 7 where the buckle of the eighth doll is mated to the strap of the seventh doll.

9. The system of claim 8 where the eye of the seventh doll is mated with the hook of the sixth doll.

10. The system of claim 9 where the hooks of the sixth doll are mated with the loops of the fifth doll.

11. The system of claim 10 where the male snap button on the extension flap of the fifth doll is coupled to the female snap button on the extension flap of the fourth doll.

12. The system of claim 11 where the male zipper component of the fourth doll is mated with the female zipper component of the third doll.

13. The system of claim 12 where the buckle of the third doll is mated with the buckle of the second doll.

14. The system of claim 13 where the button of the second doll is mated with the button hole through the extension flap of the first doll.

15. The system of claim 14 where the dolls form a circle.
